(19) United States
(12) Patent Application Publication
(10) Pub. No.: US 2011/0032291 A1
(43) Pub. Date: Feb. 10, 2011

(54) INKJET HEAD AND METHOD THEREOF

(75) Inventors: Hwa-Sun LEE, Hwaseong-si (KR); Seung-Mo LIM, Suwon-si (KR); Jae-Chang LEE, Hwaseong-si (KR); Tae-Kyung LEE, Suwon-si (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/690,956

(22) Filed: Jan. 21, 2010

(30) Foreign Application Priority Data
Aug. 4, 2009 (KR) 10-2009-0071792

(51) Int. Cl. B41J 29/38; B41J 2/045; B05D 5/06

(52) U.S. Cl. 347/9; 347/68; 427/58

(57) ABSTRACT

An inkjet head includes an ink chamber, a pressure chamber and a piezoelectric member. The ink chamber includes an ink storage area storing ink, a plurality of dampers filled with the ink to be discharged, and a plurality of nozzles connected to the dampers and discharging the ink. The pressure chamber is disposed on the ink chamber, overlapping at least two of the plurality of dampers, and includes a pressure transmitting medium. The piezoelectric member is disposed on the pressure chamber. The ink is discharged from the nozzles in substantially a same amount through control of a single piezoelectric member at one time.

This application claims priority to Korean Patent Application No. 10-2009-0071792 filed on Aug. 4, 2009, and all the benefits accruing therefrom under 35 U.S.C. §119, the entire contents of which are incorporated herein by reference.

### BACKGROUND OF THE INVENTION

(a) Field of the Invention

The invention relates to an inkjet head. (b) Description of the Related Art

Generally, various thin film patterns of flat panel displays, such as a liquid crystal display (“LCD”) and an organic light emitting diode (“OLED”) display, are formed through a photolithography process. A large-sized flat panel display necessitates an increase in a quantity of materials, such as a photosensitive film applied on a substrate to form a thin film pattern. The increase in the quantity of materials may also increase manufacturing costs, and much larger manufacturing equipment for a photolithography process may also be needed.

In order to minimize the above problems, an inkjet printing system to form a thin film pattern by dripping ink has been developed. This inkjet printing system includes an inkjet printing main body and an inkjet head including a plurality of nozzles, and the ink is dripped with a uniform volume through the nozzles of the inkjet head in a predetermined region on the substrate.

The ink discharge type of this inkjet printing system is divided into an electro-thermal transducer type (e.g., a bubble jet type) generating bubbles in the ink and discharging the ink by the force of the bubbles, and an electro-mechanical transducer type (e.g., a piezoelectric type) using a piezoelectric member and discharging the ink by the volume change of the ink generated by deformation of the piezoelectric member.

An inkjet head of the piezoelectric type includes an ink storage area, a nozzle, an ink supplying pipe, a damper, and a piezoelectric member. In the nozzle and the damper as one set, the damper has a function of condensing the pressure generated by the piezoelectric member toward the nozzle.

The inkjet head of the piezoelectric type has a complicated structure in which the piezoelectric member is disposed on each damper (e.g., a set), and the piezoelectric member must be respectively controlled such that the discharge amount of the liquid crystal from each nozzle may be changed. Where a substantially same amount of the liquid crystal is desired from all dampers

### BRIEF SUMMARY OF THE INVENTION

The invention simplifies the structure of an inkjet head, and the same discharge amount of the liquid crystal from each nozzle is realized.

An inkjet head according to an exemplary embodiment of the invention includes an ink chamber including an ink storage area storing ink, a plurality of dampers filled with the ink to be discharged, and a plurality of nozzles connected to the dampers and discharging the ink, a pressure chamber disposed on the ink chamber, overlapping at least two of the plurality of dampers, and including a pressure transmitting medium, and a piezoelectric member disposed on the pressure chamber. The ink is discharged from the nozzles of the at least two dampers in substantially a same amount, when the piezoelectric member is actuated a single time.

The pressure chamber may overlap all of the plurality of dampers included to the ink chamber, such that the ink is discharged from the nozzles connected to the plurality of dampers in substantially the same amount, when the piezoelectric member is actuated the single time.

The pressure chamber may be made of a metal, and the upper surface of the pressure chamber may be transformed by pressure.

The pressure transmitting medium may include a fluid.

The ink chamber may be made of a ceramic metal or of synthetic resins.

The upper surface of the damper may be transformed by the pressure.

A voltage generator applying a voltage to the piezoelectric member may be further included.

According to an exemplary embodiment of the invention, the pressure chamber covers all dampers of the ink chamber such that the ink may be discharged from all nozzles in a same amount through control of the piezoelectric member at one time.

Also, only one piezoelectric member is disposed in the inkjet head, such that the structure is simplified, and the ink is discharged from the nozzles of a plurality of dampers in substantially a same amount, when the only one piezoelectric member is actuated.

A method of forming a thin film pattern of a liquid crystal display, according to an exemplary embodiment of the invention includes applying a pressure in an inkjet head, discharging a substantially same amount of an ink from a plurality of a nozzle of the inkjet head and depositing the ink in the thin film pattern of the liquid crystal display. The inkjet head includes an ink chamber, a pressure chamber and a piezoelectric member.

The ink chamber includes an ink storage area storing the ink to be deposited, and a plurality of a damper filled with the ink and fluidly connected to the nozzles. The pressure chamber is disposed on the ink chamber, overlapping the plurality of the damper, and including a pressure transmitting medium. The piezoelectric member is disposed on the pressure chamber. The ink is discharged from the plurality of the nozzle of the inkjet head in the substantially same amount, by a single actuation of the piezoelectric member effecting the pressure to the ink chamber.

Also, the ink is discharged from the nozzles of the inkjet head in the substantially same amount, by actuation of a single one of the piezoelectric member effecting the pressure to the ink chamber.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 is a perspective view of an exemplary embodiment of an inkjet printing system including an inkjet head, according to the invention.

FIG. 2 is a cross-sectional view of an exemplary embodiment of the inkjet head shown in FIG. 1.

FIG. 3 is a view showing an exemplary embodiment of an ink discharge process of the inkjet head shown in FIG. 1.

FIG. 4 is a view showing an exemplary embodiment of an ink chamber of an inkjet head, according to the invention.

### DETAILED DESCRIPTION OF THE INVENTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention. In the drawings, the size and relative sizes of layers and regions may be exaggerated for clarity.

It will be understood that when an element or layer is referred to as being “on” or “connected” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “under,” “above”, and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” relative to other elements or features would then be oriented “over” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

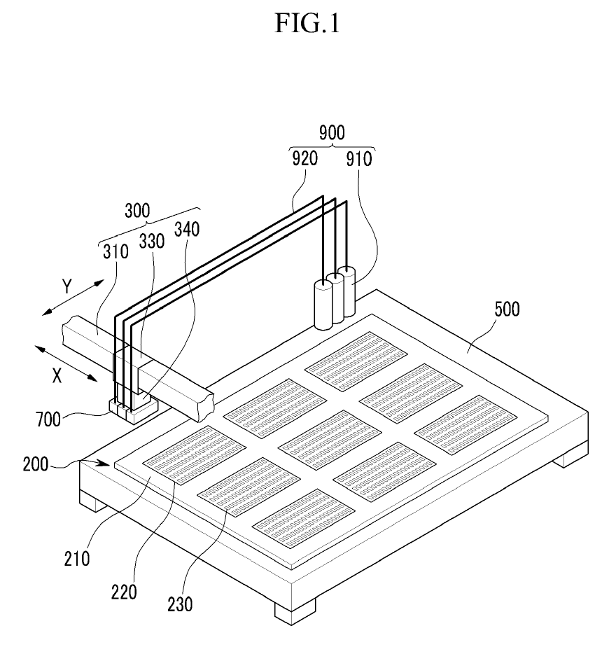

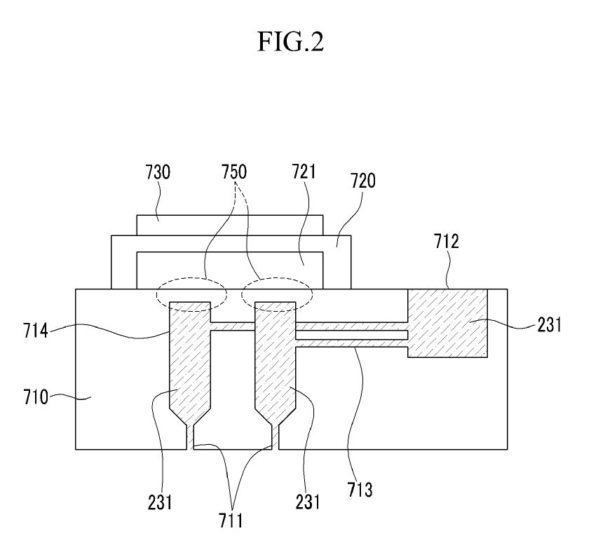

FIG. 1 is a perspective view of an exemplary embodiment of an inkjet printing system including an inkjet head, according to the invention, and FIG. 2 is a cross-sectional view of the inkjet head shown in FIG. 1.

As shown in FIG. 1, a inkjet printing system including an inkjet head according to the invention includes an inkjet head 700 dripping ink 231 on a substrate 210, a transfer unit 300 transferring the inkjet head 700, and a supply unit 900 supplying the ink 231 to the inkjet head 700.

The head unit 700 is disposed at an upper part of a stage 500 and spaced apart from an upper surface of the stage 500, by a predetermined interval from the stage 500 on which the substrate 210 is mounted. A plurality of the inkjet head 700 may be included in the inkjet printing system. In one exemplary embodiment, the plurality of the inkjet head 700 may include a red ink inkjet head, a green ink inkjet head, and a blue ink inkjet head.

The transfer unit 300 includes a support 310 for positioning the head unit 700 above the substrate 210 (e.g., overlapping in a plan view of the state 500) by the predetermined interval, a horizontal transfer part 330 which transfers the head unit 700 in first and second directions, e.g., X or Y directions, and a lifter 340 which lifts the head unit 700, for example in a third direction, e.g., Z direction, orthogonal to both the X and Y directions and perpendicular to the stage 500.

The supply unit 900 includes a plurality of an ink tank 910 each storing the ink 231, and a supplying pipe 920 supplying the ink 231 from the ink tanks 910 to the inkjet head 700. In an exemplary embodiment, a separate supplying pipe 920 may be fluidly connected to each of the ink tanks 901, respectively, as illustrated in FIG. 1. The plurality of the ink tank 910 includes a red ink tank, a green ink tank, and a blue ink tank.

To form a color filter 230 of a display substrate 200, in a thin film pattern on the substrate 210 disposed on the stage 500, the ink 231 is dripped through a plurality of a nozzle 711 of the inkjet head 700 while transferring the inkjet head 700 in the X direction by the transfer unit 300. As illustrated in FIG. 1, the ink 231 is dripped on a predetermined position relative to the substrate 210, thereby forming the color filter 230 between light blocking members 220 disposed on the substrate 210.

In an exemplary embodiment of the invention, the inkjet head 700 is used to form the color filter 230, however the inkjet head 700 may be used to form an alignment layer (not shown) or a liquid crystal layer (not shown) of the liquid crystal display.

Next, an exemplary embodiment of the structure of the inkjet head 700 will be described in detail with reference to FIG. 2.

As shown in FIG. 2, the inkjet head 700 includes an ink chamber 710 storing the ink 231 and discharging the ink 231, a pressure chamber 720 disposed on the ink chamber 710 and applying pressure to the ink chamber 710, and a piezoelectric member 730 disposed on the pressure chamber 720 and applying pressure to the pressure chamber 720 when the piezoelectric member 730 is actuated. Also, although not shown, the inkjet head 700 includes a voltage generator applying a voltage to the piezoelectric member 730. To simplify the structure, only one of the piezoelectric member 730 may be disposed in the inkjet head 700.

The ink chamber 710 is made of a ceramic, a metal, or a synthetic resin material. Referring again to FIG. 2, the ink chamber 710 includes an ink storage area 712 storing the ink 231, the plurality of the nozzle 711 which discharges the ink 231, a plurality of a damper 714 condensing energy toward the nozzle 711 and absorbing a rapid change of pressure, and an inner supplying pipe 713 supplying the ink 231 from the ink storage area 712 to the damper 714. An entire of the inner supplying pipe 713 is disposed within boundaries of the ink chamber 710. Also, the ink chamber 710 further includes a diaphragm 750 disposed between each of the dampers 714 and the pressure chamber 720, and moving according to the change of the pressure in the ink chamber 710.

The ink storage area 712, the inner supplying pipes 713, the dampers 714 and the nozzles 711 are connected to each other, such as being in fluid connection with each other, such that the ink 231 can be transferred therebetween. A unitary indivisible flow channel is defined by the fluidly connected storage area 712, inner supplying pipes 713, dampers 714 and nozzles 711. As illustrated in FIG. 2, the nozzles 711 are directly connected to outlets of the dampers 714. The ink storage area 712, the inner supplying pipes 713, the dampers 714 and the nozzles 711 may be enclosed completely within edges of the ink chamber 710, such that a body of the ink chamber 710 solely defines the ink storage area 712, the inner supplying pipes 713, the dampers 714 and the nozzles 711 of the inkjet head 700.

The pressure chamber 720 is made of the metal, and a fluid 721 having little compression, is disposed inside the pressure chamber 720 to completely fill an inside of the pressure chamber 720. The pressure chamber 720 covers a whole of all of the plurality of the dampers 714 of the ink chamber 710, such that a planar area of the pressure chamber 720 in a plan view of the inkjet head 700 overlaps the whole of the all the dampers 714.

The piezoelectric member 730 is made of a piezoelectric material of which the shape thereof is changed under the application of a voltage to actuate the piezoelectric member 730, such as lead zirconate titanate (“PZT”, (Pb(Zr₁₋ₓTiₓ)O₃), and may include a singular layer or multi-layered structure. As illustrated in FIG. 2, only one of the piezoelectric member 730 is disposed in the inkjet head 700, and on the ink chamber 710.

In contrast to a conventional structure, the inkjet head of the invention has a simplified structure in which a piezoelectric member is not disposed on each damper, and only one piezoelectric member must be controlled to affect the discharge amount of the ink from each of a plurality of nozzles in forming a thin film pattern, such a for a liquid crystal display device.

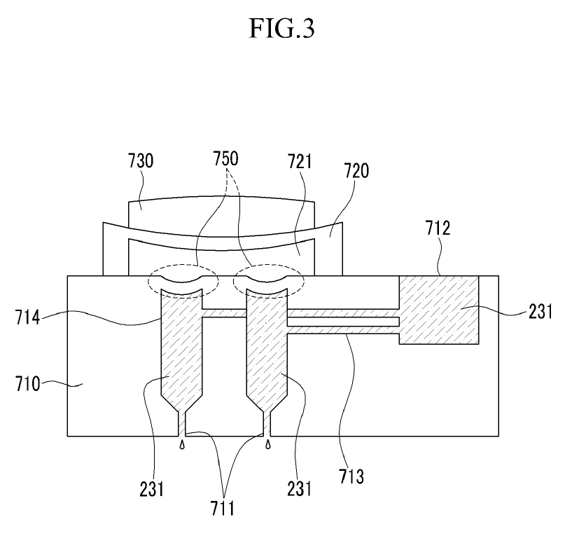

Next, a discharge process of the ink will be described with reference to FIG. 3.

FIG. 3 is a view showing an exemplary embodiment of an ink discharge process of the inkjet head shown in FIG. 1.

As shown in FIG. 3, if the voltage is applied to the only one piezoelectric member 730 which is in an initial state (e.g., no deformation and no voltage applied), the piezoelectric member 730 is transformed and physically deformed in response to the voltage, such that pressure is applied to the pressure chamber 720 under the piezoelectric member 730. Thus, the upper portion of the pressure chamber 720 receiving the pressure from the piezoelectric member 730 is transformed from an initial state and physically deformed such that the pressure is applied to the fluid 721 filled an inside of the pressure chamber 720.

The fluid 721 has little compression such that the fluid 721 does not absorb the pressure applied from the pressure chamber 720, but transfers the pressure to the ink chamber 710. In the illustrated embodiment, the upper portion of the damper 714 is made of the diaphragm 750 such that the upper portion of the damper 714 has a thin thickness compared with other parts of the damper 714, thereby generating transformation (e.g., deformation) of the diaphragm 750 from an initial state, by the pressure. Since the pressure chamber 720 covers all dampers 714 of the ink chamber 710, the deformation of the fluid 721 within the pressure chamber 720 is simultaneously applied to each of the plurality of the diaphragm 750.

The inner volume of the damper 714 is decreased by the deformation of the diaphragm 750. Accordingly, the deformation of the diaphragm 750 is translated to the inner volume of the damper 714, and the ink 231 filled inside the damper 714 receives the pressure (e.g., is physically displaced) within the damper 714. Since the damper 714 and the nozzle 711 are in fluid connection with each other, the ink 231 is discharged through the nozzle 711 by the reduction of the volume of the damper 714, as shown by drops of the ink 231 at outlets of the nozzles 711 in FIG. 3. The ink 231 is discharged directly from the outlet (e.g., distal end) of the nozzle 711, and to an outside of the inkjet head 700, to be finally deposited on the substrate 210.

When the plurality of the diaphragm 750 are simultaneously deformed by the transfer of pressure from the piezoelectric member 730 through the pressure chamber 720, each inner volume of the plurality of the damper 714 is simultaneously reduced. When the inner volumes of the dampers 714 are simultaneously reduced, the ink 231 is displaced and discharged from all nozzles 711 in substantially a same amount, through the control of the only one piezoelectric member 730 at one time (e.g., a single voltage application).

If the voltage applied to the piezoelectric member 730 is blocked (e.g., not applied), the piezoelectric member 730 is returned into the initial state, such that the inner volume of the damper 714 is increased while the pressure chamber 720 and the ink chamber 710, that is, the diaphragm 750, are returned to the respective initial (e.g., non-deformed) state. Accordingly, the pressure inside the damper 714 is decreased, and the ink 231 from the ink storage area 712 flows to an inside of the damper 714, such that the damper 714 is filled with the ink 231 from the ink storage area 712 after passing through the inner supply pipe 713.

When the plurality of the diaphragm 750 are simultaneously returned to respective initial states, each inner volume of the plurality of the damper 714 are simultaneously increased. When the inner volumes of the dampers 714 are simultaneously increased, the ink 231 may flow into all dampers 714 from the ink storage area 712 after passing through a respective inner supply pipe 713, in substantially a same amount, through the control of the only one piezoelectric member 730 at one time (e.g., a single removal of the voltage).

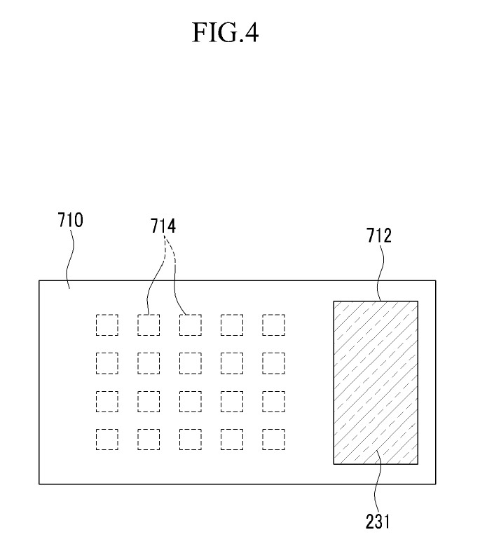

FIG. 4 is a view showing an exemplary embodiment of an ink chamber of an inkjet head, according to the invention.

As shown in FIG. 4, the ink chamber 710 includes a plurality of a damper 714. In FIG. 4, the plurality of dampers 714 are arranged at uniform intervals in a plan view of the ink chamber 710, however they may be irregularly arranged in an alternative embodiment of the invention. The plurality of dampers 714 collectively form a damper group which is spaced at a distance from boundaries of the ink storage area 712. The planar area of the pressure chamber 720 overlaps a whole of the damper group.

When the plurality of the diaphragm 750 are simultaneously deformed from or returned to respective initial states, an inner volume of the damper group are simultaneously decreased or increased. When the inner volume of damper group is simultaneously decreased or increased, the ink 231 may flow out of or into an entire of the damper group, at substantially the same time in substantially a same amount, through the control of the only one piezoelectric member 730 at one time.As described above, in the inkjet head according to an exemplary embodiment of the invention, the pressure chamber 720 covers all dampers 714 of the ink chamber 710 such that the ink 231 may be discharged from all nozzles 711 at substantially the same time and at substantially a same amount, through the control of the piezoelectric member 730 at one time.

While the invention has been described in connection with what is considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An inkjet head comprising:
an ink chamber including:
an ink storage area storing ink,
a plurality of a damper filled with the ink which is discharged from the dampers, and
a plurality of a nozzle fluidly connected to the dampers, and through which the ink is discharged from the inkjet head;
a pressure chamber disposed on the ink chamber, overlapping at least two of the plurality of the damper, and including a pressure transmitting medium; and
a piezoelectric member disposed on the pressure chamber,
wherein the ink is discharged from the nozzles of the at least two of the dampers in substantially a same amount, when the piezoelectric member is actuated a single time.

2. The inkjet head of claim 1, wherein
the pressure chamber overlaps all of the plurality of dampers of the ink chamber, such that the ink is discharged from all of the dampers of the inkjet head in substantially the same amount, when the piezoelectric member is actuated the single time.

3. The inkjet head of claim 2, wherein
the pressure chamber includes a metal, and
an upper surface of the pressure chamber is deformed by pressure generated through the actuation of the piezoelectric member.

4. The inkjet head of claim 3, wherein
the pressure transmitting medium includes a fluid.

5. The inkjet head of claim 4, wherein
the ink chamber includes a ceramic, a metal, or a synthetic resin.

6. The inkjet head of claim 5, wherein
an upper surface of the damper is deformed by the pressure.

7. The inkjet head of claim 6, further comprising
a voltage generator applying a voltage to the piezoelectric member, such that the piezoelectric member is actuated.

8. The inkjet head of claim 1, wherein
the pressure chamber includes a metal, and
an upper surface of the pressure chamber is deformed by pressure generated through the actuation of the piezoelectric member.

9. The inkjet head of claim 8, wherein
the pressure transmitting medium includes a fluid.

10. The inkjet head of claim 1, wherein
the ink chamber includes a ceramic, a metal, or a synthetic resin.

11. The inkjet head of claim 1, wherein the inkjet head includes only one of the piezoelectric member.

12. A method of forming a thin film pattern of a liquid crystal display, the method comprising:
applying a pressure in an inkjet head;
discharging a substantially same amount of an ink from a plurality of a nozzle of the inkjet head; and
depositing the ink in the thin film pattern of the liquid crystal display,
wherein the inkjet head comprises:
an ink chamber including:
an ink storage area storing the ink to be deposited, and
a plurality of a damper filled with the ink and fluidly connected to the nozzles;
a pressure chamber disposed on the ink chamber, overlapping the plurality of the damper, and including a pressure transmitting medium; and
a piezoelectric member disposed on the pressure chamber,
wherein the ink is discharged from the nozzles of the inkjet head in the substantially same amount, by a single actuation of the piezoelectric member effecting the pressure to the ink chamber.

13. The method of claim 12, wherein
the piezoelectric member effecting the pressure to the ink chamber includes, deforming an upper surface of the pressure chamber by pressure generated through the single actuation of the piezoelectric member.

14. The method of claim 13, wherein
the deforming an upper surface of the pressure chamber includes, deforming an upper surface of the damper, which discharges the ink from the nozzles connected to the dampers.

15. The method of claim 12, wherein the substantially same amount of the ink from the plurality of the nozzle of the inkjet head is discharged as substantially a same time, by the single actuation of the piezoelectric member.

16. The method of claim 12, wherein the inkjet head includes only one of the piezoelectric member.
